(19) United States
(12) Patent Application Publication
(10) Pub. No.: US 2025/0067386 A1
(43) Pub. Date: Feb. 27, 2025

(54) COLLAPSIBLE DEVICE MOUNTING ARM

(71) Applicants: Robert M. Wynalda, JR., Comstock Park, MI (US); David Wynalda, Comstock Park, MI (US)

(72) Inventors: Robert M. Wynalda, JR., Comstock Park, MI (US); David Wynalda, Comstock Park, MI (US)

(21) Appl. No.: 18/814,548

(22) Filed: Aug. 25, 2024

Related U.S. Application Data
(60) Provisional application No. 63/578,919, filed on Aug. 25, 2023.

(51) Int. Cl. F16M 11/20

(52) U.S. Cl. CPC F16M 11/2092; F16M 11/2014; F16M 2200/028

(57) ABSTRACT

A camera arm includes a plurality of adjustable length arms. The arms are joined with a pivot pin to allow them to fully rotate with respect to each other. Each adjustable length arm is adjustable between collapsed and expanded conditions. Adjustable length arm configurations are provided wherein an inner arm section defines an elongated slot that receives a locking device carried by an outer arm section. The arm can include rollers or slides that provide for a stable expanded condition and smooth movements between the arm sections.

### CROSS REFERENCE TO RELATED APPLICATIONS

This application claims the benefit of U.S. Provisional patent application No. 63/578,919 filed Aug. 25, 2023; the disclosures of which are incorporated herein by reference.

### BACKGROUND OF THE DISCLOSURE

### 1. Technical Field

The present disclosure generally relates to device mounting arms that are configurable between expanded and collapsed conditions. The collapsed condition allows the arm to consume minimal space when packed for carrying it into a location where it will be used such as a hunting location. The expanded condition provides for a variety of arm section lengths that allow the user to customize the arm configuration for a particular device and location.

### 2. Background Information

Mounting a camera or other electronic device in a desirable orientation in an area to be hunted is not an easy task. Traditional tripods placed on the ground are subject to being knocked over by wild game and can spook some game. Mounting devices to trees require straps that wrap around the tree or spikes that are inserted into the tree. Different mounts are known to be strapped and ratcheted to trees. These mounts are configured to support camera arms.

Cameras can be used to capture images of wild game during the hunt, capture images of what game is on a game trail at different times during the day, or capture images or video of the hunter in action. Motion sensors can provide warnings to a hunter that there is movement along a trail in an area that cannot be directly viewed by the hunter.

Many electronic devices and most cameras that are not built into mobile phones include a threaded opening for mounting the device with a tripod mount screw. When the devices include the threaded opening, a threaded support screw such as a tripod mount screw can be threaded into the opening to secure the device to a mount such as a tripod or a base mounting bracket. The screws are typically a ¼ inch, 20 thread. This means that the screw has a diameter of ¼ inch and 20 threads per inch. However, some tripods may use a ⅜ inch, 16 thread instead, which has a larger diameter and fewer threads per inch. New devices built into mobile phones often do not include the threaded openings. These devices are typically held by clamping mounting devices that grasp opposite sides of the device.

A hunter often packs in a variety of equipment to the designated hunt site and there is a benefit to having compact gear or gear that can be collapsed for travel.

### SUMMARY OF THE DISCLOSURE

The disclosure provides camera or device arms that are configurable between expanded and collapsed conditions. The camera arm includes one or a plurality of adjustable length arms. Each adjustable length arm is adjustable between a collapsed condition and an expanded condition. The arm can be locked in these conditions and any position between these conditions. The collapsed condition the benefit of a compact arm that minimizes the space required to pack it during transport to a location where the arm is to be used. The expanded condition allows the arm to have the reach and range as a typical camera or device arm. The conditions between the collapsed and expanded conditions allow the user to customize the arm for a particular location. One exemplary configuration of the arm includes two adjustable length arms that each has a plurality of expanded conditions with each arm of the camera arm being continuously adjustable and lockable at any position between its collapsed condition and its fully expanded condition. Another exemplary configuration provides an adjustable length arm that is continuously adjustable and lockable at any position between its collapsed condition and its fully expanded condition. The adjustable length arm includes an elongated slot that defines the available range of the adjustability and a plurality of rollers for smooth adjustments and a stable locked condition. The collapsed conditions of the arms reduce the packing space required by the camera.

In one configuration, the disclosure provides a camera or device arm that includes two adjustable arms connected at their outer or second ends so that the arms pivot with respect to each other. Each arm can rotate up to 360 degrees with respect to an adjacent arm. In one configuration, the first arm has a first end that defines a mount which can be a hole that receives a mounting post or a post that is slid into a mounting hole. The post or mounting hole can be provided on a camera arm mount that is mounted to a stable structure such as a tree stand or a tree. The second end of the first arm supports a pivot pin upon which the second end of the second arm is received. When only two arms are used, the first end of the second arm supports a mount for a device. The mount can be a threaded camera mount or a clamp that holds a mobile phone. The device 18 to be mounted can be a camera, a spotting scope, a light, a motion sensor, a range finder, or another device that is useful for hunting.

In another configuration, the disclosure provides an adjustable length arm having an inner arm section that defines an elongated slot. A clamping fastener carried by an outer arm section passes through the elongated slot continuously adjustable and lockable at any position between its collapsed condition and its fully expanded condition. One end of the elongated slot defines the collapsed condition for the adjustable arm while the other end of the elongated slot defines the expanded condition. The clamping fastener can be tightened to lock the position of the inner and outer arm sections.

In another configuration, one or both of the inner and outer arm sections carry rollers or slides such as cylindrical rollers to aid the movement of the two sections with respect to each other and to provide a tight fit between the sections when they are locked. These rollers can be used with the inner arm section that defines the elongated slot to provide a compact camera arm that provides a stable expanded position for holding a device such as a camera.

In all of these configurations, each adjustable length arm can be locked in its collapsed position, its fully expanded position, and a plurality of expanded positions between the collapsed position and the fully expanded position. Each arm carries a locking device that is configurable between locked and unlocked conditions with the locked condition locking the position of the arm and the unlocked condition allowing length adjustments to be made. Different types of locking devices can be used. An exemplary looking device includes a threaded lock finger carried by the outer arm section. The threaded lock finger can be rotated to a locked condition where it engages the inner arm section. Another exemplary locking device is a collar that has a threaded locking fastener or an adjustable lock lever that uses a cam and follower to tighten the collar when configured in the locked condition. These locking devices allow the user to select the length of the arm at any position between its fully collapsed and fully expanded positions. In another configuration, the inner and outer arm sections define a plurality of spaced holes or spaced recesses. The holes or recesses provide a plurality of discrete lengths for the arm and a locking pin is used to retain the arm in the selected position.

The disclosure also provides a camera arm where the inner and outer arm sections of each arm include a feature that prevents the sections from rotating with respect to each other about the longitudinal dimension of the arm section. In the exemplary configuration, the feature is a tab that extends inwardly from the outer arm section in combination with a corresponding groove defined by the inner arm section. The tab is received in the groove and prevents relative rotation. Both the tab and groove can be elongated along the length of the arm sections.

The preceding non-limiting aspects of the disclosure, as well as others, are more particularly described below. A more complete understanding of the devices, assemblies, and methods can be obtained by reference to the accompanying drawings, which are not intended to indicate relative size and dimensions of the assemblies. In those drawings and the description below, like numeric designations refer to components of like function. Specific terms used in that description are intended to refer only to the particular structure of the embodiments selected for illustration in the drawings, and are not intended to define or limit the scope of the disclosure.

### BRIEF DESCRIPTION OF THE DRAWINGS

FIG. 1 is a schematic elevation view of a first embodiment of the collapsible camera arm.

FIG. 2 is an isometric view of the camera arm of FIG. 1 with both arms in their collapsed conditions.

FIG. 3 is an isometric view of the camera arm of FIG. 1 with both arms in their expanded conditions.

FIG. 4 is an isometric view of a second embodiment of a camera arm in its expanded condition.

FIG. 5 is an isometric view of the camera arm of FIG. 4 in a position between the expanded condition and the collapsed condition.

FIG. 6 is a section view taken along lines 6-6 of FIG. 4.

FIG. 7 is a section view taken along line 7-7 of FIG. 5.

FIG. 8 is an isometric view of the outer arm section of the camera arm of FIG. 4.

FIG. 9 is an isometric view of the inner arm section of the camera arm of FIG. 4.

### DETAILED DESCRIPTION OF THE DISCLOSURE

This description of exemplary embodiments is intended to be read in connection with the accompanying drawings, which are to be considered part of the entire written description.

The drawing figures are not necessarily to scale, and certain features may be shown exaggerated in scale or in somewhat schematic form in the interest of clarity and conciseness. In the description, relative terms such as “horizontal,” “vertical,” “up,” “down,” “top” and “bottom” as well as derivatives thereof (e.g., “horizontally,” “downwardly,” “upwardly,” etc.) should be construed to refer to the orientation as then described or as shown in the drawing figure under discussion. These relative terms are for convenience of description and normally are not intended to require a particular orientation. Terms including “inwardly” versus “outwardly,” “longitudinal” versus “lateral” and the like are to be interpreted relative to one another or relative to an axis of elongation, or an axis or center of rotation, as appropriate. Terms concerning attachments, coupling and the like, such as “joined,” “connected,” and “interconnected,” refer to a relationship wherein structures are secured or attached to one another either directly or indirectly through intervening structures, as well as both movable or rigid attachments or relationships, unless expressly described otherwise.

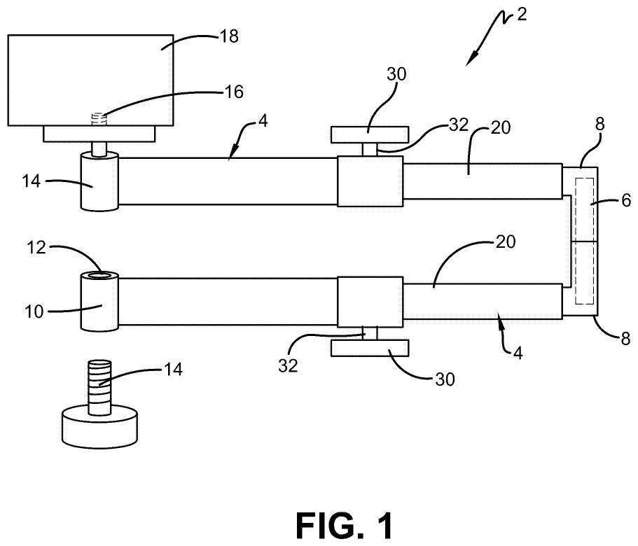

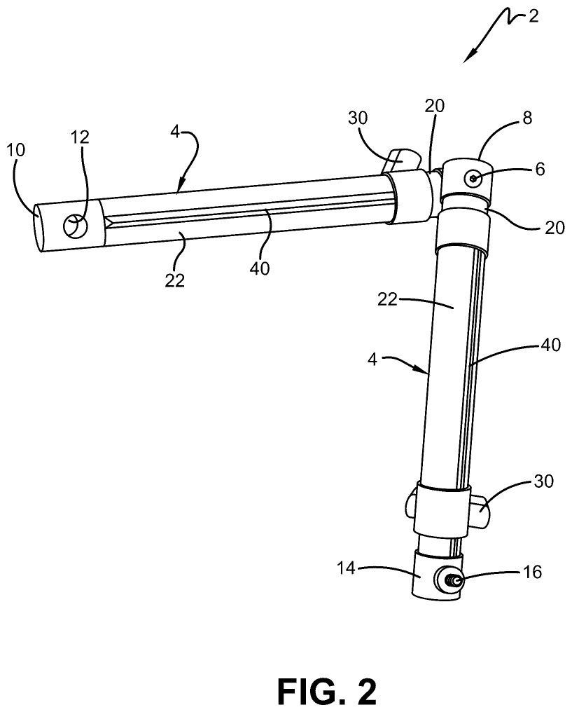

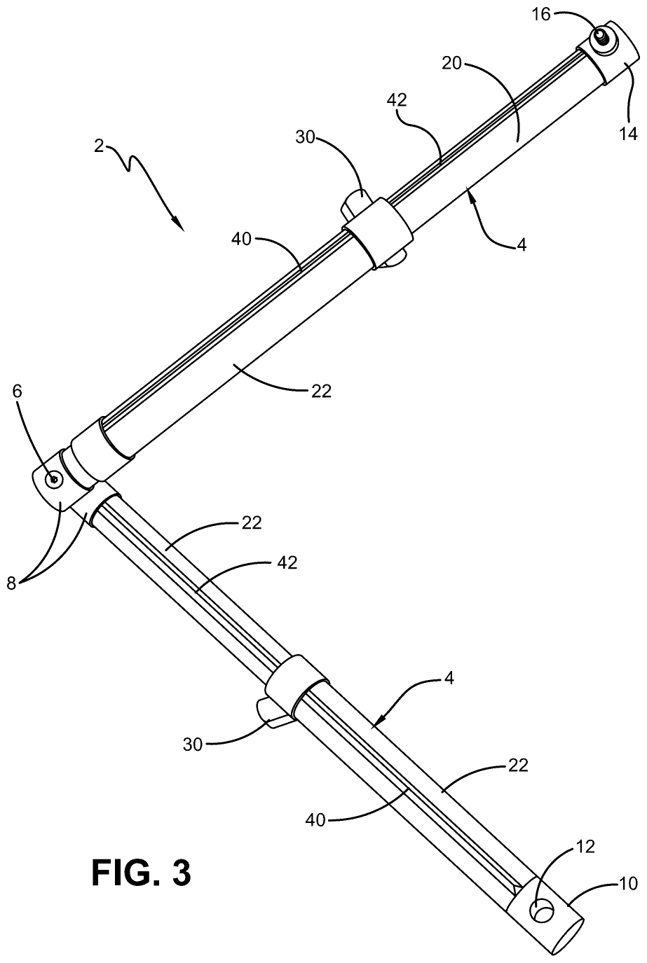

A first exemplary configuration of the collapsible camera arm is indicated generally by the number 2 in FIGS. 1-3. In the context of this application, a camera arm is used to hold cameras and other electronic devices such as mobile phones, spotting scopes, motion sensors, lights, or other equipment. Camera arm 2 can be used to hold a camera used to film a hunt. Camera arm 2 is configurable between expanded (FIGS. 1 and 3) and collapsed (FIG. 2) conditions. Camera arm 2 includes at least two adjustable length arms 4 that pivot with respect to each other. In the exemplary configuration, arm 2 includes first and second adjustable length arms 4. Each arm can rotate 360 degrees with respect to the other adjustable length arm 4 on a pivot pin 6 that connects the second ends 8 of adjustable length arms 4. The first adjustable length arm 4 has a first end 10 that defines a first mount which can be a hole 12 that receives a mounting post 14. Alternatively, the first mount can be a post that is slid into a mounting hole. Additional options for the first mount include a threaded opening or threaded post. The post or mounting hole that supports camera arm 2 when mounted can be provided on a camera arm mounting bracket that is secured to a stable structure such as a tree stand, a hunting blind, or a tree. The first end 14 of the second adjustable length arm 4 supports a second mount 16 for a device 18. Second mount 16 can be an opening that receives a post as above, a threaded camera support screw, or a clamp that holds a mobile phone or another device for its sides. Second mount 16 can be threaded into first end 14 or molded into place. The device 18 to be mounted can be a camera, a spotting scope, a light, a motion sensor, a range finder, or another device that is useful for hunting. The exemplary configuration of the camera arm has two adjustable length arms 4 that each has a plurality of expanded conditions with each adjustable length arm 4 of the camera arm 2 being continuously adjustable and lockable at any position between its collapsed condition and its fully expanded condition. The collapsed conditions of the adjustable length arms 4 reduce the packing space required by the camera arm 2.

Each adjustable length arm 4 can be locked in its collapsed position, its fully expanded position, and a plurality of partially expanded positions between the collapsed position and the fully expanded position. Each adjustable length arm 4 includes an inner arm section 20 and an outer arm section 22 that are slidable with respect to each other. Each adjustable length arm 4 carries a locking device 30 that is configurable between locked and unlocked conditions with the locked condition locking the position of the adjustable length arm 4. Different types of locking devices 30 can be used. In the exemplary configuration, locking devices 30 include a threaded lock finger 32 carried by outer arm section 22. Threaded lock finger 32 can be rotated to a locked condition where it engages inner arm section 20. Another exemplary locking device is a collar that has an adjustable lock lever that uses a cam and follower to tighten the collar when the lock lever is moved to the locked condition (lever lock). The threaded lock finger 32 and the lock lever with collar allow the user to select the length of the adjustable length arm 4 at any position between its fully collapsed and fully expanded positions. In another configuration, the inner 20 and outer 22 arm sections define a plurality of holes (or recesses defined by inner arm section 20). The holes provide a plurality of discrete lengths for adjustable length arm 4 and a locking pin is used to retain adjustable length arm 4 in the selected position.

Inner 20 and outer 22 arm sections of each adjustable length arm 4 include a feature that prevents the sections from rotating with respect to each other about the longitudinal dimension of adjustable length arm 4. In the exemplary configuration, the feature is a tab 40 that extends inwardly from outer arm section 22 in combination with a corresponding groove 42 defined by inner arm section 20. Tab 40 is received in groove 42 and prevents relative rotation. Tab 40 and groove 42 can be reversed such that tab 40 projects out from inner arm section 20 and groove 42 is defined by outer arm section 20. Both tab 40 and groove 42 can be elongated along the lengths of arm sections 20 and 22. In other configuration, inner 20 and outer 22 arm sections are provided with non-circular cross sections to prevent relative rotation.

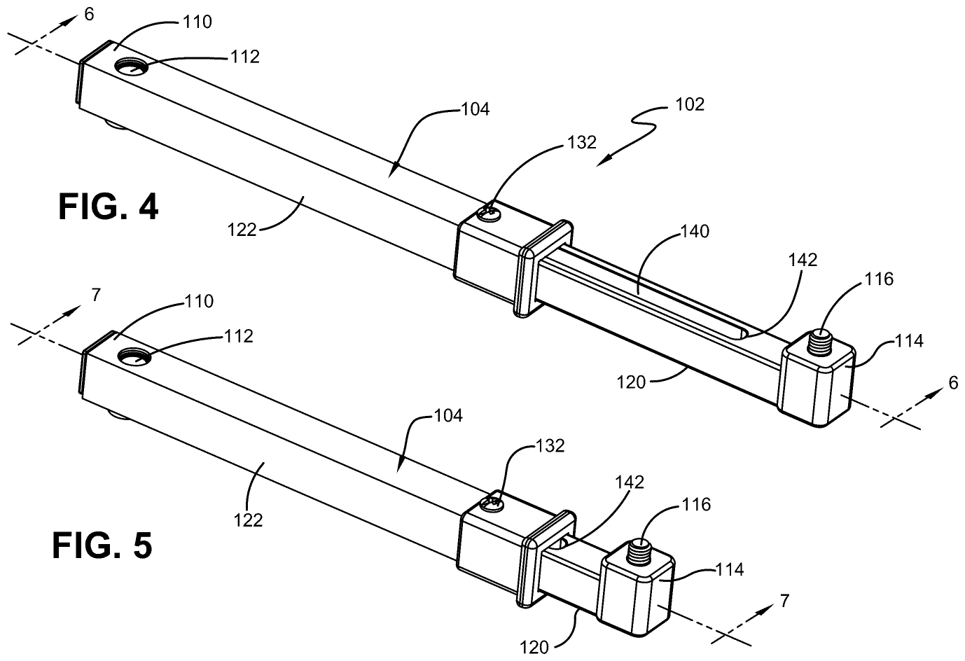

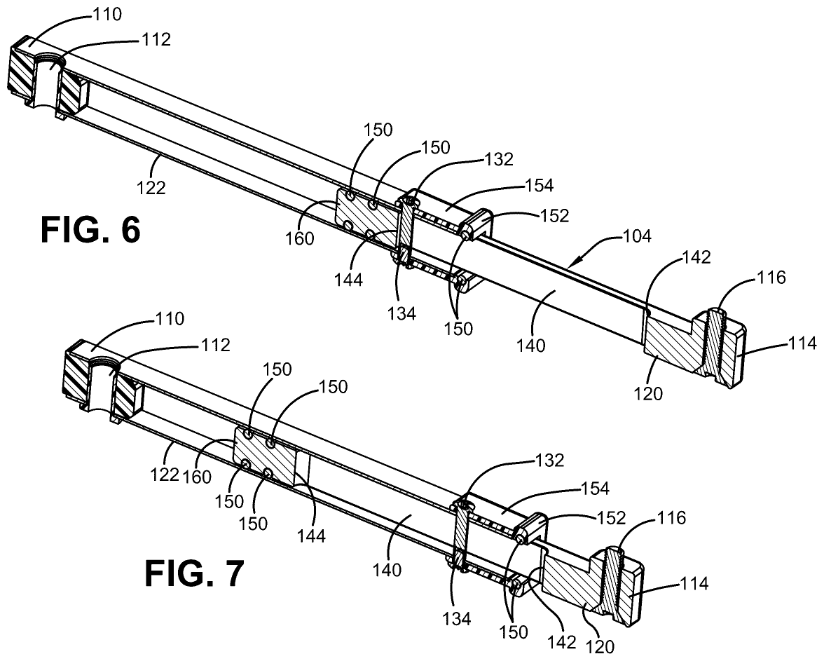

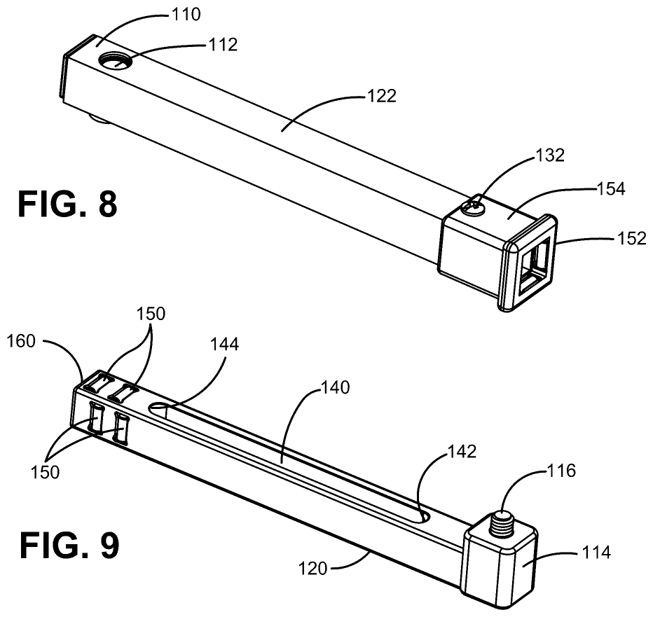

A second exemplary configuration of the collapsible camera arm is indicated generally by the number 102 in FIGS. 4-9. The drawings depict a configuration of camera arm 102 with a single adjustable arm 104. Other configurations of camera arm 102 include a plurality of adjustable arms 104 connected to pivot with respect to each other as described above. Camera arm 102 is configurable between expanded (FIGS. 4 and 6) and collapsed (not shown) conditions. FIGS. 5 and 7 depict partially expanded conditions for camera arm 102.

Adjustable length arm 104 has a first end 110 that defines a first mount that allows camera arm 102 to be carried by a mounting bracket or a tripod. In this configuration, the first mount is a sleeve 112 that defines hole that receives a mounting post (not shown) projecting from the mounting bracket or tripod. The mounting post slides into sleeve 112 and allows arm 102 to rotate around the post. Such a mounting bracket can be secured to a tree, a blind, or a tree stand. Alternatively, the first mount can be a projecting mounting post that is slid into a mounting hole defined by a sleeve or other structure on the mounting bracket or tripod. Other options include a threaded opening or threaded post. In the exemplary configuration, first end 110 includes a first solid body portion that receives and supports sleeve 112. Other than the first solid body portion, the outer arm section 122 is hollow so that it can receive the inner arm section 120.

In this configuration, the second end 114 of adjustable length arm 104 supports a second mount 116 for a device 18. Second mount 116 can be a threaded camera mount or a clamp that holds a mobile phone or another device. Mount 116 can be threaded into and extend through a second solid body portion located at second end 114 from below as shown in FIGS. 6 and 7. The device 18 to be mounted can be a camera, a spotting scope, a light, a motion sensor, a range finder, or another device that is useful for hunting. The collapsed condition of the adjustable length arm 104 reduces the packing space required by the camera arm 102.

Adjustable length arm 104 can be locked in its collapsed position, its fully expanded position, and a plurality of partially expanded positions between the collapsed position and the fully expanded position. Adjustable length arm 104 includes inner arm section 120 and outer arm section 122 that are slidable with respect to each other. Adjustable length arm 104 carries a locking device that is configurable between locked and unlocked conditions with the locked condition locking the position of adjustable length arm 104. Different types of locking devices are used in different configuration of the arm. In the exemplary configuration, the locking device includes first 132 and second 134 threaded fasteners carried by outer arm section 122. Threaded fasteners 132 and 134 can be rotated relative to each other to a locked condition where they cooperate to compress a portion of outer arm section 122 against inner arm section 120 to lock their positions together. Unthreading fasteners 132 and 134 unlocks the two sections. Another exemplary locking device is a collar that has an adjustable lock lever that uses a cam and follower to tighten the collar when the lock lever is moved to the locked condition. Locking devices such as threaded fasteners 132 and 134 and the lock lever with collar allow the user to select the length of adjustable length arm 104 at any position between its fully collapsed and fully expanded positions. In another configuration, the inner 120 and outer 122 arm sections define a plurality of holes (or recesses defined by inner arm section 120). The holes provide a plurality of discrete lengths for adjustable length arm 104 and a locking pin is used to retain adjustable length arm 104 in the selected position.

Inner arm section 120 defines an elongated slot 140 partially defined by a first end 142 and a second end 144. At least a portion of the locking device extends into elongated slot 140. In the configuration depicted in the drawings, first 132 and second 134 threaded fasteners project into elongated slot 140. Second fastener 134 is received within the internally threaded end of first fastener 132. The adjustment between the two fasteners 132 and 134 occurs internally so that neither portion protrudes farther from second arm section 122 when in the locked condition compared to the unlocked condition. When arm sections 120 and 122 are moved relative to each other to a position where the locking device engages first end 142, adjustable length arm 104 is in its fully collapsed condition. When arm sections 120 and 122 are moved relative to each other to a position where the locking device engages second end 144, adjustable length arm 104 is in its fully expanded condition. In the exemplary configuration depicted in the drawings, first fastener 132 engages ends 142 and 144.

In one configuration, adjustable length arm 104 includes a plurality of rollers 150 that provide smooth controlled movement between inner 120 and outer 122 arm sections as well as helping to provide for a tight fit between the two sections when they are locked. In the exemplary configuration of camera arm 102, inner 120 and outer 122 arm sections have rectangular cross sections and rollers 150 are cylindrical. When other cross-sectional shapes are used for arm sections 120 and 122, rollers 150 can be spherical ball bearings or tapered roller bearings. Each roller 150 is made from a metal, a ceramic, or a polymer. Each roller 150 is either rotatably carried in a roller pocket or non-rotatably carried such that it functions as a slide. Each roller 150 can rotate or remain fixed during use from time to time and function as a slide that provides the desired smooth movement and support. Each roller 150 can be snap fit into its pocket or slid in from the end.

Four rollers 150 are located at a second end 152 of outer arm section 122. These are located along the four sides of a collar 154 that also supports the locking device such as fastener 132 and nut 134. In the exemplary configuration, the end of collar 154 at second end 152 is enlarged to provide the pockets for rollers 150. The enlarged second end 152 is spaced at the opposite end of collar from the locking device. These four rollers (two horizontal and two vertical) engage the four sides of inner arm section 120. Each roller 150 has a length sized to engage a majority of the width/height of the surfaces of inner arm section 120. In one configuration, each of these rollers 150 contacts at least eighty percent of the available surface.

An inner end 160 of inner arm section 120 is defined by a third solid body portion that defines the pockets that receive rollers 150. In this configuration, two rollers 150 are carried at each of the four sides of inner arm section 120 to engage the four inner surfaces of outer arm section 122. These rollers 150 are also sized to contact a majority of the length of the surface which they engage and the contact patch can be eighty percent or more. As shown in FIG. 9, the horizontal rollers 150 located at the top and bottom are offset from the vertical rollers 150 located on the sidewalls to provide room for all sixteen of their ends. The eight spaced rollers 150 carried by inner arm section 120 cooperate with the four rollers carried by outer arm section 122 to provide a stable locked condition when adjustable length arm 104 is in its fully expanded condition as shown in FIG. 6.

In the foregoing description, certain terms have been used for brevity, clearness, and understanding. No unnecessary limitations are to be implied therefrom beyond the requirement of the prior art because such terms are used for descriptive purposes and are intended to be broadly construed. Moreover, the above description and attached illustrations are an example and the invention is not limited to the exact details shown or described. Throughout the description and claims of this specification the words “comprise” and “include” as well as variations of those words, such as “comprises,” “includes,” “comprising,” and “including” are not intended to exclude additives, components, integers, or steps.

1. An adjustable device mounting arm comprising:
first and second adjustable length arms;
each of the first and second adjustable length arms having a first end and a second end;
the second ends of the first and second adjustable length arms being rotatably joined to allow the second adjustable length arm to rotate with respect to the first adjustable length arm;
each of the first and second adjustable length arms having an inner arm section, an outer arm section, and a locking device; the inner arm section being selectively slidable with respect to the outer arm section to adjust the length of the adjustable length arm;
the first end of the first adjustable length arm defining a first mount; and
the first end of the second adjustable length arm defining a second mount.

2. The mounting arm of claim 1, wherein one of the inner and outer arm sections includes a tab and the other of the inner and outer arm sections defines a groove; the tab being receive in the groove to prevent the inner arm section from rotating with respect to the outer arm section.

3. The mounting arm of claim 1, wherein the inner and outer arm sections have noncircular cross sections; a portion of the inner arm section selectively sliding inside a portion of the outer arm section.

4. The mounting arm of claim 3, wherein the outer arm section carries a plurality of rollers that engage the inner arm section.

5. The mounting arm of claim 4, wherein the inner arm section carries a plurality of rollers that engage the outer arm section.

6. The mounting arm of claim 5, wherein the inner arm section defines an elongated slot; a portion of the locking device extending into the elongated slot.

7. The mounting arm of claim 6, wherein the inner arm defines a first end and a second end that define the ends of the elongated slot; the adjustable length arm is in a fully collapsed condition when the inner and outer arm sections are moved relative to each other to a position where the portion of the locking device engages the first end; and the adjustable length arm is in a fully expanded condition when the inner and outer arm sections are moved relative to each other to a position where the portion of the locking device engages the second end.

8. The mounting arm of claim 7, wherein the locking device includes first and second threaded fasteners the project into the elongated slot; the second fastener being received within an internally threaded end of the first fastener.

9. The mounting arm of claim 5, wherein the inner arm section has four sides and the outer arm section carries four rollers that engage the four sides of the inner arm section.

10. The mounting arm of claim 9, wherein the outer arm section includes four inner surfaces; the inner arm section carrying at least four rollers that engage the four inner surfaces of the outer arm section.

11. The mounting arm of claim 10, wherein the inner arm section has one top roller, one bottom roller and two side rollers; the top and bottom rollers being offset from the side rollers in a direction along a length of the inner arm section.

12. The mounting arm of claim 11, wherein the inner arm section has two spaced top rollers, two spaced bottom roller and four spaced side rollers; the top and bottom rollers being offset from the side rollers in a direction along a length of the inner arm section.

13. An adjustable length device mounting arm comprising:
an outer arm section;
an inner arm section a portion of the inner arm section selectively sliding inside a portion of the outer arm section;
the outer arm section carrying a plurality of rollers that engage the inner arm section;
the inner arm section carrying a plurality of rollers that engage the outer arm section;
the inner arm section defining an elongated slot;
a locking device adapted to selectively lock the position of the inner arm section with respect to the outer arm section; a portion of the locking device extending into the elongated slot;
the inner arm defines a first end and a second end that define the ends of the elongated slot; the adjustable length arm is in a fully collapsed condition when the inner and outer arm sections are moved relative to each other to a position where the portion of the locking device engages the first end; and
the adjustable length arm is in a fully expanded condition when the inner and outer arm sections are moved relative to each other to a position where the portion of the locking device engages the second end.

14. The mounting arm of claim 13, wherein the locking device includes first and second threaded fasteners the project into the elongated slot; the second fastener being received within an internally threaded end of the first fastener.

15. The mounting arm of claim 13, wherein the inner arm section has four sides and the outer arm section carries four rollers that engage the four sides of the inner arm section.

16. The mounting arm of claim 15, wherein the outer arm section includes four inner surfaces; the inner arm section carrying at least four rollers that engage the four inner surfaces of the outer arm section.

17. The mounting arm of claim 13, wherein the inner arm section has one top roller, one bottom roller and two side rollers; the top and bottom rollers being offset from the side rollers in a direction along a length of the inner arm section.

18. The mounting arm of claim 17, wherein the inner arm section has two spaced top rollers, two spaced bottom roller and four spaced side rollers; the top and bottom rollers being offset from the side rollers in a direction along a length of the inner arm section.
